(19) United States
(12) Patent Application Publication
(10) Pub. No.: US 2024/0029321 A1
(43) Pub. Date: Jan. 25, 2024

(54) IMAGE PROCESSING METHOD, IMAGE PROCESSING APPARATUS, STORAGE MEDIUM, IMAGE PROCESSING SYSTEM, METHOD OF GENERATING MACHINE LEARNING MODEL, AND LEARNING APPARATUS

(71) Applicant: CANON KABUSHIKI KAISHA, Tokyo (JP)

(72) Inventor: YUKINO ONO, Tochigi (JP)

(21) Appl. No.: 18/352,639

(22) Filed: Jul. 14, 2023

(30) Foreign Application Priority Data
Jul. 20, 2022 (JP) 2022-115905

(51) Int. Cl. G06T 11/00; G06T 3/00

(52) U.S. Cl. CPC G06T 11/00; G06T 3/0093

(57) ABSTRACT

An image processing method includes acquiring a second image obtained by applying geometric transformation to a first image, acquiring information about a deformation amount of the first image in the geometric transformation, and generating a third image based on the second image and the information about the deformation amount.

### BACKGROUND

### Field of the Disclosure

The present disclosure relates to a technique for correcting deterioration in image quality caused by application of geometric transformation to an image.

### Description of the Related Art

When an object is imaged using a fisheye lens, a clear wide-range image can be obtained. However, the image acquired using the fisheye lens is largely distorted toward the edges. Therefore, it is necessary to correct distortion of the image acquired using the fisheye lens by geometric transformation. Image quality of the image subjected to the geometric transformation is largely deteriorated in a region where a deformation amount (correction amount) of the image by the geometric transformation is large.

Y. Zhang et al., “Toward Real-world Panoramic Image Enhancement”, IEEE/CVF Conference on Computer Vision and Pattern Recognition Workshops (CVPRW), 2020, pp. 2675-2684 discusses a method of correcting, by using a machine learning model, deterioration in image quality caused by application of geometric transformation to an image.

By the method discussed in Y. Zhang et al., “Toward Real-world Panoramic Image Enhancement”, IEEE/CVF Conference on Computer Vision and Pattern Recognition Workshops (CVPRW), 2020, pp. 2675-2684, deterioration in image quality is corrected with a fixed deformation amount for each pixel irrespective of geometric transformation applied to the image. Therefore, depending on the geometric transformation applied to the image, insufficient correction or excessive correction may occur.

### SUMMARY

Some embodiments of the present disclosure realize a technique for correcting deterioration in image quality caused by application of geometric transformation to an image, with high accuracy.

According to an aspect of the present disclosure, an image processing method includes acquiring a second image obtained by applying a geometric transformation to a first image, acquiring information about a deformation amount of the first image in the geometric transformation, and generating a third image based on the second image and the information about the deformation amount.

Further features of various embodiments will become apparent from the following description of exemplary embodiments with reference to the attached drawings.

### BRIEF DESCRIPTION OF THE DRAWINGS

FIG. 1 is a diagram illustrating a flow of generation of an estimated image according to a first exemplary embodiment.

FIG. 2 is a block diagram illustrating an image processing system according to the first exemplary embodiment.

FIG. 3 is an appearance diagram of the image processing system according to the first exemplary embodiment.

FIG. 4 is a diagram illustrating a flow of weight update according to the first exemplary embodiment.

FIG. 5 is a flowchart illustrating the weight update according to the first exemplary embodiment.

FIG. 6 is a flowchart illustrating an image processing method according to the first exemplary embodiment.

FIG. 7 is an explanatory diagram of information about a deformation amount according to the first exemplary embodiment.

FIG. 8 is a block diagram illustrating an image processing system according to a second exemplary embodiment.

FIG. 9 is an appearance diagram of the image processing system according to the second exemplary embodiment.

FIG. 10 is a flowchart illustrating an image processing method according to the second exemplary embodiment.

FIG. 11 is an explanatory diagram of information about a deformation amount according to the second exemplary embodiment.

FIG. 12 is a block diagram illustrating an image processing system according to a third exemplary embodiment.

FIG. 13 is a flowchart illustrating an image processing method according to the third exemplary embodiment.

### DESCRIPTION OF THE EMBODIMENTS

Some exemplary embodiments of the present disclosure are described in detail below with reference to drawings. In the drawings, the same members are denoted by the same reference numerals, and repetitive description is omitted.

Before the exemplary embodiments are specifically described, a summary of the exemplary embodiments is first described.

Geometric transformation according to each of the exemplary embodiments is performed, for example, in order to reduce distortion aberration and chromatic aberration caused by characteristics of an optical system in an imaging apparatus used to acquire a first image. Further, the geometric transformation may be performed in order to convert an image acquired using an optical system (e.g., fisheye lens) that adopts a projection method different from a central projection method and forms an image of a wide range while distorting an object, into an image expressed by a projection method or a display method different from the projection method or the display method of an original image. Examples of the projection method of the image obtained by the geometric transformation include an equidistance projection method, an equisolid angle projection method, an orthogonal projection method, a stereographic projection method, and the central projection method. Examples of the display method of the image obtained by the geometric transformation include an azimuthal projection method, a cylindrical projection method, and a conical projection method.

Deterioration in image quality caused by the geometric transformation in the present exemplary embodiment is caused by deterioration in resolution or occurrence of aliasing noise. Deterioration in resolution is caused by shift of a frequency component toward a low frequency relative to a Nyquist frequency. On the other hand, aliasing noise indicates that a false structure not included in an original object occurs in the image due to aliasing of a frequency component relatively higher than the Nyquist frequency toward the low frequency side. The frequency component in the image is varied by a deformation amount of the image in the geometric transformation. Therefore, a theoretical value (calculation value) of the aliasing noise can be determined based on the deformation amount.

In each of the exemplary embodiments, information about the deformation amount of the image is expressed by a ratio (magnification rate or reduction rate) of corresponding shapes (line segments or areas) in the images before and after the geometric transformation. However, the information about the deformation amount is not limited thereto. For example, the information about the deformation amount may be expressed by a moving amount from one point in a first image to one point in a second image corresponding to the one point in the first image. The deformation amount of the image may be varied depending on a position in the image, in some methods of the geometric transformation. At this time, deterioration in image quality caused by the geometric transformation is also varied depending on the position in the image. Note that a pixel in the image indicates a region of the image corresponding to one pixel of an imaging device of an imaging apparatus used to acquire the image. Further, the information about the deformation amount may include deformation amounts for a plurality of different regions in the first image or a deformation amount for each pixel.

When processing is performed based on the information about the deformation amount of the first image in the geometric transformation applied the first image, and the second image, it is possible to perform correction processing corresponding to deterioration in image quality for each pixel of the second image. Therefore, deterioration in image quality caused by geometric transformation with high accuracy in the second image can be corrected, and insufficient correction and excessive correction can be reduced.

Note that, in each of the exemplary embodiments, deterioration in image quality caused by the geometric transformation in the second image may be corrected using a machine learning model.

In each of the exemplary embodiments, the machine learning model is generated by performing learning using a neural network. The machine learning model may be learned by genetic programming, a Bayesian network, or the like. As a neural network, a convolutional neural network (CNN), a generative adversarial network (GAN), a recurrent neural network (RNN), or the like can be adopted. The neural network uses filters to be convolved with an image, biases to be added to the image, and activation functions performing nonlinear transformation. The filters and the biases are called weights, and updated (learned) using training images and ground truth images.

In each of the exemplary embodiments, the step is called a learning phase. Further, an image processing method according to each of the exemplary embodiments performs processing for outputting an estimated image in which deterioration in image quality (deterioration in resolution) caused by application of the geometric transformation to the image is corrected, by inputting the image generated by the geometric transformation and the above-described information about the deformation amount to the machine learning model. In each of the exemplary embodiments, the step is called an estimation phase. Note that the above-described image processing method is illustrative, and some embodiments are not limited thereto. Details of the other image processing method and the like are described in the following exemplary embodiments.

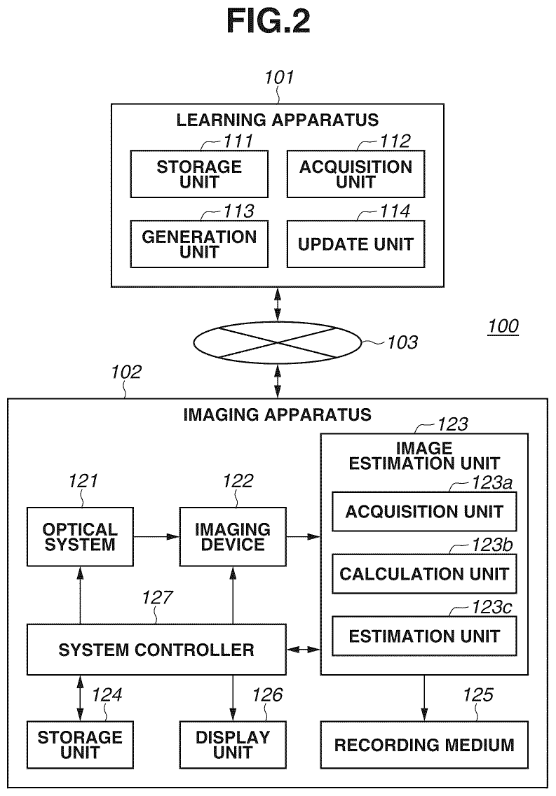

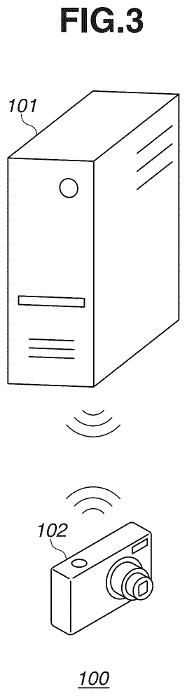

An image processing system 100 according to a first exemplary embodiment will be described with reference to FIG. 2 and FIG. 3. In the present exemplary embodiment, the machine learning model is caused to learn and perform processing for correcting deterioration in image quality caused by geometric transformation. FIG. 2 is a block diagram of the image processing system 100 according to the present exemplary embodiment. FIG. 3 is an appearance diagram of the image processing system 100. The image processing system 100 includes a learning apparatus 101 and an imaging apparatus 102. The learning apparatus 101 and the imaging apparatus 102 are connected to each other via a wired or wireless network 103.

The learning apparatus 101 includes a storage unit 111, an acquisition unit 112, a generation unit 113, and an update unit 114, and determines weights of the machine learning model.

The imaging apparatus 102 includes an optical system 121, an imaging device 122, an image estimation unit 123, a storage unit 124, a recording medium 125, a display unit 126, and a system controller 127. The optical system 121 collects light entering from an object space to generate an object image. The optical system 121 includes functions such as a zooming function, an aperture adjusting function, and an auto-focusing function as necessary. The present exemplary embodiment is based on the premise that the optical system 121 includes distortion aberration. The imaging device 122 converts the object image generated by the optical system 121 into an electric signal, and generates an original image. Examples of the imaging device 122 include a charge coupled device (CCD) sensor and a complementary metal-oxide semiconductor (CMOS) sensor.

The image estimation unit 123 includes an acquisition unit 123a, a calculation unit 123b, and an estimation unit 123c. The image estimation unit 123 acquires the original image, and generates an input image by geometric transformation. The image estimation unit 123 further generates an estimated image by using the machine learning model. Deterioration in image quality caused by the geometric transformation is corrected using a multilayer neural network. Information about weights in the multilayer neural network is generated by the learning apparatus 101. The imaging apparatus 102 previously reads out the information about the weights from the storage unit 111 via the network 103, and stores the information about the weights in the storage unit 124. The stored information about the weights may be a numerical value of the weights itself, or may be in a decoded form. Details about weight update and estimated image generation using the weights will be described below. The image estimation unit 123 includes a function of generating an output image by performing development processing and other image processing as necessary. The estimated image may be used as the output image. As the image estimation unit 123, a processor in the imaging apparatus 102, an external device, or other storage medium can be used.

The recording medium 125 records the output image. The display unit 126 displays the output image in a case where a user issues an instruction about output of the output image. The above-described operation is controlled by the system controller 127.

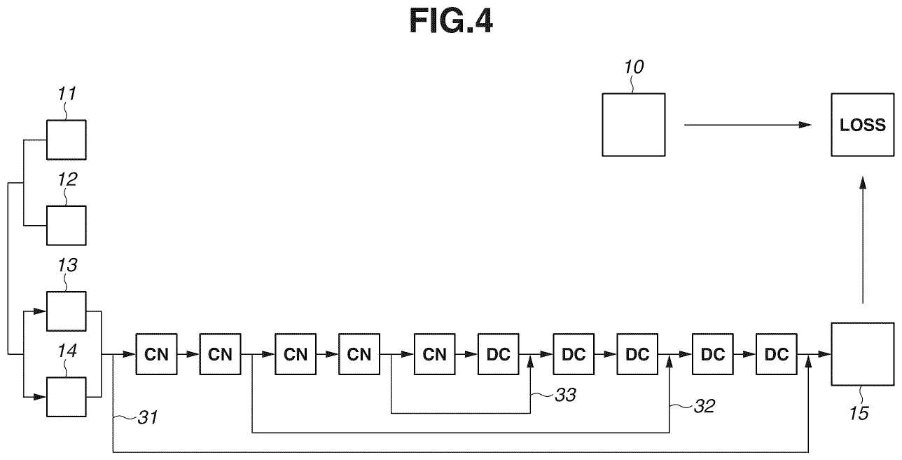

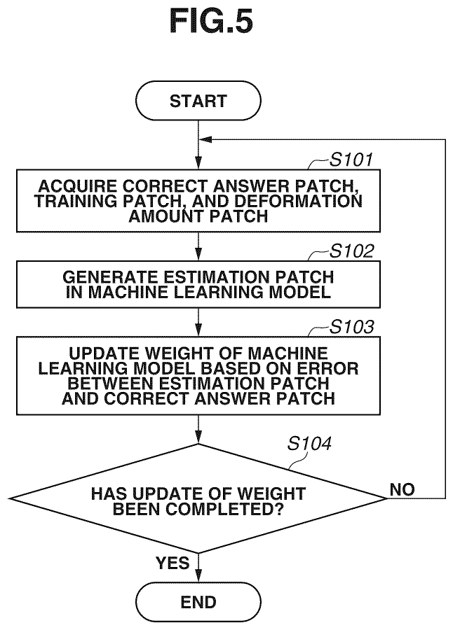

Next, a method of updating the weights (information about weights) (method of manufacturing learned model) executed by the learning apparatus 101 according to the present exemplary embodiment is described with reference to FIG. 4 and FIG. 5.

FIG. 4 is a diagram illustrating a flow of the learning phase. FIG. 5 is a flowchart illustrating the weight update. Steps in FIG. 5 are mainly executed by the acquisition unit 112, the generation unit 113, and the update unit 114.

First, in step S101, at least one ground truth patch, at least one training patch, and at least one deformation amount patch are acquired. The ground truth patch, the training patch, and the deformation amount patch are generated by the generation unit 113. The patch indicates an image including a prescribed number of pixels (e.g., 64×64 pixels). Generation of the ground truth patch, the training patch, and the deformation amount patch is described below.

Subsequently, in step S102, the generation unit 113 generates an estimation patch by inputting the training patch and the deformation amount patch to a multilayer machine learning model. The estimation patch is an image obtained by the machine learning model from the training patch, and is ideally coincident with the ground truth patch. Each of convolution layers CN and deconvolution layers DC calculates convolutions and deconvolutions of the input and the filter respectively, and a sum with the bias, and performs processing on the result by using the activation function. Components of each filter and an initial value of each bias are optional, and are determined by a random number in the present exemplary embodiment. As the activation function, for example, a rectified linear unit (ReLU) or a sigmoid function can be used. An output from each of the layers except for a final layer is called a feature map. Each of skip connections 32 and 33 combine the feature maps output from the discontinuous layers. The feature maps may be combined by element-wise sum or by concatenation in a channel direction. In the present exemplary embodiment, the element-wise sum is adopted. A skip connection 31 calculates a sum of the training patch and an estimated residual between the training patch and the ground truth patch, thereby generating the estimation patch. In the present exemplary embodiment, a configuration of a neural network illustrated in FIG. 4 is used as the machine learning model; however, the present exemplary embodiment is not limited thereto.

Subsequently, in step S103, the update unit 114 updates the weights of the machine learning model based on an error between the estimation patch and the ground truth patch. In the present exemplary embodiment, the weights include the components of the filter and the bias in each of the layers. A backpropagation is used for updating the weights; however, the present exemplary embodiment is not limited thereto. In a case of mini batch learning, errors between a plurality of ground truth patches and a plurality of estimation patches corresponding thereto are determined, and the weights are updated. As a loss function, for example, an L2 norm or an L1 norm is used. However, the present exemplary embodiment is not limited thereto, and online learning or batch learning may be used.

Subsequently, in step S104, the update unit 114 determines whether update of the weights has been completed. Completion of the update can be determined based on whether the number of repetitions of the weight update has reached a predetermined number of times or whether a change amount of the weights in the update is less than a predetermined value. In a case where it is determined that update of the weights has not been completed (NO in step S104), the processing returns to step S101, and the acquisition unit 112 acquires one or more new sets of the ground truth patch, the training patch, and the deformation amount patch. In contrast, in a case where it is determined that update of the weights has been completed (YES in step S104), the update unit 114 ends the learning, and stores the information about the weights in the storage unit 111.

Next, a learning data generation method will be described. The learning data includes the ground truth patch, the training patch, and the deformation amount patch, and is mainly generated by the generation unit 113.

First, the generation unit 113 acquires a ground truth image 10, a first training image 12, and information 11 about the optical system corresponding to the first training image 12, from the storage unit 111.

The ground truth image 10 includes a plurality of images, and may be an image acquired by the imaging apparatus 102 or a computer graphics (CG) image. The ground truth image 10 may be expressed by grayscale, or may contain a plurality of channel components. In a case where the ground truth image 10 includes the images obtained by imaging various objects, it is possible to improve robustness of the machine learning model to the various objects. For example, the ground truth image 10 may include the images including edges, textures, gradations, flat portions, and the like with various intensities in various directions. As necessary, information about the optical system corresponding to the ground truth image 10 may be stored in the storage unit 111.

In the present exemplary embodiment, the information 11 about the optical system is information about distortion aberration of the optical system used to acquire the first training image 12, and is stored as a lookup table representing relationships between an ideal image height and an actual image height of the optical system, in the storage unit 111. The ideal image height is an image height obtained in a case of no aberration, and the actual image height is an image height actually obtained in a case where the distortion aberration is added. The lookup table is generated for each imaging condition. The imaging condition includes, for example, a focal length, an F-number, and an object distance. A distortion aberration D [%] is expressed by the following equation (1) using an ideal image height r and an actual image height r′,

D=(r′−r)/r·100. (1)

However, the information 11 about the optical system is not limited to the lookup table representing the relationship between the ideal image height and the actual image height of the optical system, and may be stored as a distortion aberration amount of the optical system. The information 11 about the optical system 11 may be, for example, a lookup table representing relationships between the ideal image height and the distortion aberration amount or relationships between the actual image height and the distortion aberration amount.

In the present exemplary embodiment, the first training image 12 is an image obtained by imaging the same object as the object of the ground truth image 10, and includes the distortion aberration derived from the optical system. As the first training image 12, an image generated by applying the geometric transformation based on the ground truth image 10 and the information about the optical system corresponding to the ground truth image 10 may be used.

Further, before the geometric transformation is applied to the ground truth image 10, processing for reducing aliasing noise generated in the first training image 12 may be performed (anti-aliasing processing). Performing the anti-aliasing processing corresponding to the deformation amount on the ground truth image 10 makes it possible to reduce the aliasing noise generated in the first training image 12 to a desired level.

Subsequently, a second training image 13 and information about a deformation amount (first deformation amount) of the first training image 12 in the geometric transformation are generated. The second training image 13 and the information 14 about the deformation amount are calculated from the information 11 about the optical system and the first training image 12.

The second training image 13 is an image obtained by applying the geometric transformation to the first training image 12 based on the information 11 about the optical system. The second training image 13 may be subjected to interpolation processing as necessary. As a method of the interpolation processing, a known interpolation method, such as nearest neighbor interpolation, bilinear interpolation, and bicubic interpolation, can be used. In a case where an optical axis is not coincident with a center in each of the images before and after the transformation, it is necessary to consider a shift amount from the optical axis to the center in each of the images. Further, the second training image 13 may be an undeveloped raw image. In a case where learning is performed using a raw image and a developed image respectively as the second training image 13 and the ground truth image 10, the generated machine learning model can perform development processing in addition to correction of deterioration in image quality caused by the geometric transformation. The development processing is processing for converting the raw image into an image file in a format of Joint Photographic Experts Group (JPEG), tagged image file format (TIFF), or the like.

The information 14 about the deformation amount is information expressed by a scalar value or a two-dimensional map (feature map), and indicates the deformation amount from a shape in the first training image 12 to a corresponding shape in the second training image 13. A plurality of deformation amounts each from a shape in the first training image 12 to a corresponding shape in the second training image 13 may be acquired for respective positions. The shape is, for example, a distance between two points (line segment) or an area of a region in the first training image 12, and a distance between corresponding two points or an area of a corresponding region in the second training image 13. In a case where the deformation amount is expressed by a rate, for example, the deformation amount can be expressed by a magnification rate that is increased as the image is magnified and is decreased as the image is reduced, or a reduction rate that is decreased as the image is magnified and is increased as the image is reduced. Further, the deformation amount of the image may be expressed using a difference (change amount) between corresponding shapes in the images before and after the geometric transformation. Furthermore, the deformation amount of the image may be expressed using a moving amount from one point in a first image 22 to one point in the second image corresponding to the one point in the first image 22.

In the present exemplary embodiment, the information 14 about the deformation amount is two or more types of two-dimensional maps indicating deformation amounts corresponding to directions different from each other in the geometric transformation. In the present exemplary embodiment, the information 14 about the deformation amount is expressed by two types of two-dimensional maps corresponding to a horizontal direction and a vertical direction that are arrangement directions of the pixels. The deformation amount in the horizontal direction is a value calculated using a distance between two optional points in the horizontal direction in the second training image 13 and a distance between two points in the first training image 12 corresponding to the distance between the two optional points in the horizontal direction in the second training image 13. The two-dimensional map in the horizontal direction is generated by determining a plurality of deformation amounts based on the distance between the two optional points in each of the first training image 12 and the second training image 13. The two-dimensional map in the vertical direction can be generated in a similar manner. The two-dimensional map including the deformation amounts at many different positions in each of the first training image 12 and the second training image 13 is generated, which makes it possible to generate a machine learning model that can correct deterioration in image quality with high accuracy.

Note that the examples of the two types of two-dimensional maps indicating the deformation amounts in the horizontal direction and the vertical direction are described; however, the deformation amounts may be deformation amounts in a plurality of directions different from one another. For example, two directions that are a direction inclined by 45 degrees and a direction inclined by 135 degrees from the horizontal direction, or two directions that are a concentric direction and a radiation direction may be used. As the information 14 about the deformation amount, the deformation amount calculated for a partial region of the image, or a deformation amount for all of corresponding pixels in the second training image 13 calculated by interpolation or the like, from the deformation amount of the partial region may be used. Further, the information 14 about the deformation amount may be subjected to normalization processing.

Further, a plurality of sets of the second training image 13 and the information 14 about the deformation amount may be extracted from the first training image 12 and the information 11 about the optical system. The number of patches to be extracted may be biased based on the deformation amount indicated by the information 14 about the deformation amount. For example, a large number of patches are extracted from a region where the deformation amount is large, which makes it possible to update the weights high in effect of correcting deterioration in image quality.

In the relationship between the second training image 13 and the ground truth image 10, a sampling pitch of the second training image 13 and a sampling pitch of the ground truth image 10 may be different from each other as long as the second training image 13 and the ground truth image 10 include the same object. For example, the ground truth image 10 and the second training image 13, the sampling pitch of which is less than the sampling pitch of the ground truth image 10, are combined and used as the learning data, which makes it possible to generate the machine learning model that can perform upscale processing in addition to correction of deterioration in image quality caused by the geometric transformation. The upscale processing is processing for making the sampling pitch of the output image smaller than the sampling pitch of the input image in the estimation phase.

Finally, the ground truth patch, the training patch, and the deformation amount patch are generated. The ground truth patch, the training patch, and the deformation amount patch are respectively generated by extracting an image of a prescribed number of pixels from a region indicating the same object in the ground truth image 10, the second training image 13, and the information about the deformation amount. Note that the ground truth image 10, the second training image 13, and the information about the deformation amount can be respectively used as the ground truth patch, the training patch, and the deformation amount patch. Further, the deformation amount patch in the present exemplary embodiment includes different pixel values depending on positions in the patch; however, the pixel values in the patch may be equal to one another. For example, a patch in which each of the pixels has an average value of the pixel values or the pixel value at a center position in the deformation amount patch according to the present exemplary embodiment may be used. Further, learning may be performed by using, in place of the deformation amount patch, the average value of the pixel values or the pixel value at the center position in the patch, as a scalar value.

Further, to generate the learning data, an image acquired by the imaging apparatus 102 may be used. At this time, if the acquired image is used as the first training image 12, the second training image 13 can be generated. At this time, the ground truth image 10 can be obtained by imaging the object same as the object of the first training image 12, by using an optical system less in distortion aberration than the optical system 121.

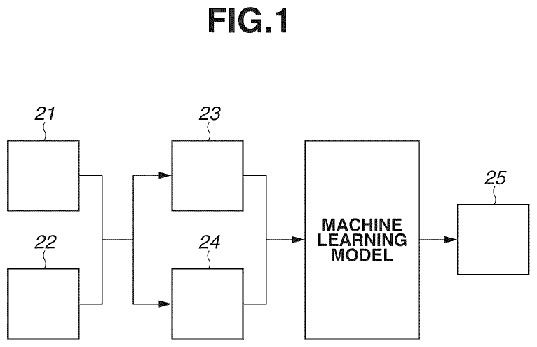

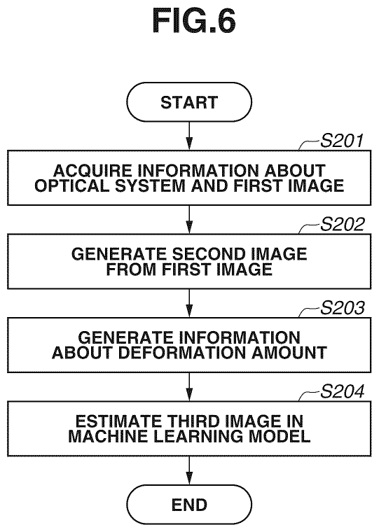

Next, the image processing method (estimation phase) using the learned machine learning model will be described in detail with reference to FIG. 1 and FIG. 6. FIG. 1 is a diagram illustrating a flow of the estimation phase. FIG. 6 is a flowchart illustrating the estimation phase according to the present exemplary embodiment. Steps in FIG. 6 are performed by the acquisition unit 123a, the calculation unit 123b, or the estimation unit 123c of the image estimation unit 123.

First, in step S201, the acquisition unit 123a acquires information 21 about the optical system, the first image 22, and the information about the weights. The information 21 about the optical system is previously stored in the storage unit 124, and the acquisition unit 123a acquires the information 21 about the optical system corresponding to the imaging condition. The information about the weights is previously read out from the storage unit 111, and is stored in the storage unit 124. The information 21 about the optical system corresponds to the information 11 about the optical system in the learning phase. Further, the first image 22 corresponds to the first training image 12 in the learning phase.

Subsequently, in step S202, the calculation unit 123b generates a second image 23 from the information 21 about the optical system and the first image 22. In the present exemplary embodiment, the second image 23 is an image generated by applying the geometric transformation to the first image 22 in order to reduce the distortion aberration generated in the first image 22 caused by the optical system 121.

The second image 23 corresponds to the second training image 13 in the learning phase, and is an image obtained by applying the geometric transformation to the first image 22 based on the information 21 about the optical system. Further, the second image 23 may be subjected to interpolation processing as necessary.

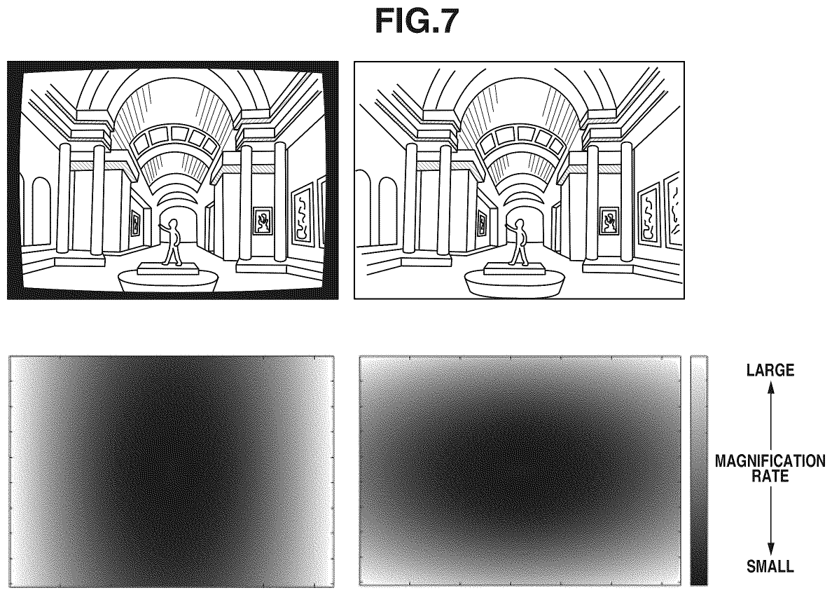

Subsequently, in step S203, the calculation unit 123b generates information 24 about the deformation amount (second deformation amount) of the first image 22 in the geometric transformation, by using the information 21 about the optical system and the first image 22. The information 24 about the deformation amount indicates a deformation amount in generation of the second image 23 in step S202. In the present exemplary embodiment, the information 24 about the deformation amount is two types of two-dimensional maps indicating the deformation amounts in the horizontal direction and the vertical direction. The information 24 about the deformation amount in the present exemplary embodiment will be described with reference to FIG. 7. An upper left diagram in FIG. 7 illustrates an example of the first image 22, and an upper right diagram in FIG. 7 illustrates an example of the second image 23. A lower left diagram in FIG. 7 is a two-dimensional map indicating the deformation amount in the horizontal direction when the second image 23 is generated from the first image 22. A lower right diagram in FIG. 7 is a two-dimensional map indicating the deformation amount in the vertical direction when the second image 23 is generated from the first image 22. In the present exemplary embodiment, the two types of two-dimensional maps illustrated as the lower left diagram and the lower right diagram in FIG. 7 correspond to the information 24 about the deformation amount. A method of generating the information 24 about the deformation amount is similar to the method of generating the information 14 about the deformation amount. Note that steps S202 and S203 in the present exemplary embodiment may be processed at the same time.

In a case where, in step S202, a plurality of second images 23 is generated using a plurality of first images 22 and a plurality of pieces of information 21 about the optical system corresponding to the plurality of first images 22, a plurality of pieces of information 24 about the deformation amount can be acquired.

At this time, the plurality of first images 22 are subjected to correction of distortion aberration by the each geometric transformation.

The image estimation unit 123 may be included in an image processing apparatus different from the imaging apparatus 102. In this case, the image acquired by the acquisition unit 123a may be not the first image 22 but an image corresponding to the second image 23. In other words, the image processing apparatus different from the image estimation unit 123 may previously perform step S202 to generate the second image 23 from the information 21 about the optical system and the first image 22.

Subsequently, in step S204, the estimation unit 123c generates an estimated image (third image) 25 by inputting the second image 23 and the information 24 about the deformation amount to the machine learning model. The third image 25 is an image obtained by correcting deterioration in the image quality caused by the geometric transformation, in the second image 23.

As described above, according to the present exemplary embodiment, it is possible to provide the image processing system that can correct deterioration in image quality caused by the geometric transformation with high accuracy, in the second image 23 reduced in distortion aberration by the geometric transformation.

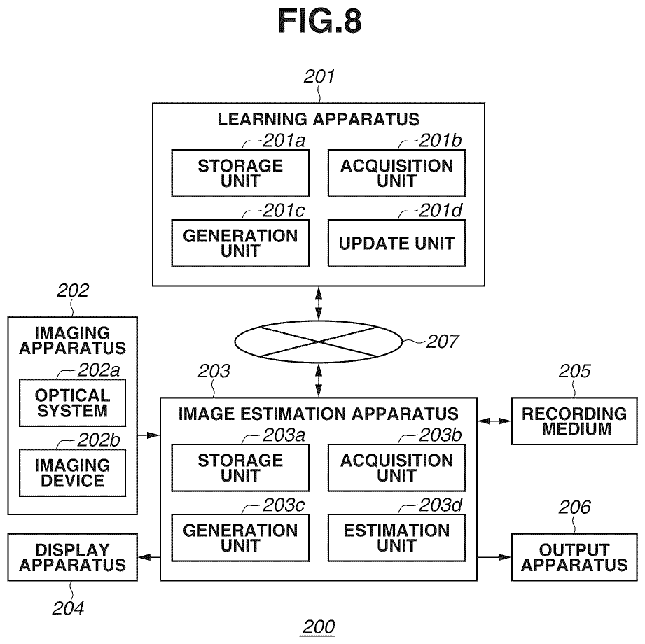

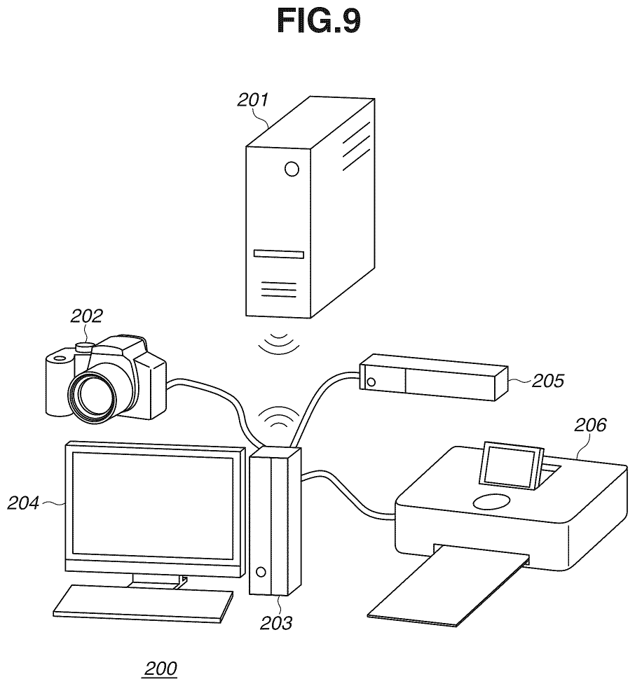

Next, an image processing system 200 according to a second exemplary embodiment will be described with reference to FIG. 8 and FIG. 9. In the present exemplary embodiment, the machine learning model is caused to learn and perform processing for correcting deterioration in image quality caused by geometric transformation. The image processing system 200 according to the present exemplary embodiment is different from the first exemplary embodiment in that an original image is acquired from an imaging apparatus 202 and an image estimation apparatus 203 performs image processing. FIG. 8 is a block diagram of the image processing system 200 according to the present exemplary embodiment. FIG. 9 is an appearance diagram of the image processing system 200. The image processing system 200 includes a learning apparatus 201, the imaging apparatus 202, the image estimation apparatus 203, a display apparatus 204, a storage medium 205, an output apparatus 206, and a network 207.

The learning apparatus 201 includes a storage unit 201a, an acquisition unit 201b, a generation unit 201c, and an update unit 201d, and the learning apparatus 201 determines weights of the machine learning model.

The imaging apparatus 202 includes an optical system 202a and an imaging device 202b, and the imaging apparatus 202 acquires the first image 22. The optical system 202a collects light entering from an object space to generate an object image. The imaging device 202b converts the object image generated by the optical system 202a into an electric signal, and the imaging device 202b generates the first image 22. The optical system 202a according to the present exemplary embodiment includes a fisheye lens adopting the equisolid angle projection method, and an object of the first image 22 includes distortion corresponding to the equisolid angle projection method. Note that the optical system 202a is not limited thereto, and an optical system adopting an arbitrary projection system may be used.

The image estimation apparatus 203 includes a storage unit 203a, an acquisition unit 203b, a generation unit 203c, and an estimation unit 203d. The image estimation apparatus 203 generates an estimated image by using the machine learning model. In the following, geometric transformation according to the present exemplary embodiment is transformation from the first image 22 expressed by the equisolid angle projection method (first projection method) into the second image 23 expressed by the central projection method (second projection method). The present exemplary embodiment is not limited thereto, and an image expressed by an arbitrary projection method or expression method may be used. The processing for correcting deterioration in image quality caused by the geometric transformation is performed using the machine learning model, and information about the weights of the machine learning model is generated by the learning apparatus 201. The image estimation apparatus 203 reads out the information about the weights from the storage unit 201a via the network 207, and stores the information about the weights in the storage unit 203a. Update of the weights performed by the learning apparatus 201 is similar to the update of the weights performed by the learning apparatus 101 according to the first exemplary embodiment. Therefore, description thereof is omitted. Further, details of the learning data generation method and the image processing using the weights are described below. The image estimation apparatus 203 may include a function of generating an output image by performing development processing and other image processing as necessary.

The output image generated by the image estimation apparatus 203 is output to at least one of the display apparatus 204, the storage medium 205, and the output apparatus 206. The display apparatus 204 is, for example, a liquid crystal display or a projector. The user may perform an editing work and the like while checking an image under processing, through the display apparatus 204. The storage medium 205 is, for example, a semiconductor memory, a hard disk, or a server on the network, and stores the output image. The output apparatus 206 is, for example, a printer.

The storage medium 205 records the output image. The display apparatus 204 displays the output image in a case where the user issues an instruction about output of the output image. The above-described operation is controlled by a system controller 127.

Next, the learning data generation method will be described. The learning data includes the ground truth patch, the training patch, and the deformation amount patch, and is mainly generated by the generation unit 201c.

First, the acquisition unit 201b acquires the ground truth image 10 and the information 11 about the optical system corresponding to the ground truth image 10 from the storage unit 201a. In the present exemplary embodiment, the ground truth image 10 is an image acquired by the optical system adopting the central projection method.

In the present exemplary embodiment, the information 11 about the optical system includes information about the projection method adopted by the optical system used to acquire each image. The projection method indicates a method in which an optical system having a focal length f expresses an object present at an angle θ from an optical axis on a two-dimensional plane by using an image height r of the optical system.

The equisolid angle projection method is a projection method characterized in that a solid angle and an area on the two-dimensional plane of the object are proportional to each other. The optical system adopting the equisolid angle projection method expresses the object on the two-dimensional plane as described by the following equation (2),

r=2.f.sin(θ/2). (2)

The optical system adopting the central projection method expresses the object on the two-dimensional plane as described by the following equation (3),

r=f·tanθ. (3)

The information 11 about the optical system is not limited to the relationship between the angle of the object from the optical axis and the image height of the optical system as long as the information 11 about the optical system can associate the position of the object with the position on the two-dimensional plane in which the object is expressed.

Subsequently, the first training image 12 is generated. In the present exemplary embodiment, the first training image 12 is an image obtained by imaging the object same as the object of the ground truth image 10, and is an image acquired by the optical system adopting the equisolid angle projection method. Note that the projection method of the first training image 12 is not limited thereto.

Subsequently, the second training image 13 and the information 14 about the deformation amount are generated. The second training image 13 and the information 14 about the deformation amount are calculated from the information 11 about the optical system and the first training image 12. The second training image 13 is an image generated by applying the geometric transformation to the first training image 12 expressed by the equisolid angle projection method, and is expressed by the central projection method. Further, the second training image 13 may be subjected to interpolation processing as necessary. The second training image 13 is not limited thereto as long as the second training image 13 is at least expressed by a projection method similar to the projection method of the ground truth image 10.

The information 14 about the deformation amount is generated by a method similar to the method in the first exemplary embodiment. Further, the ground truth patch, the training patch, and the deformation amount patch are generated by a method similar to the method in the first exemplary embodiment.

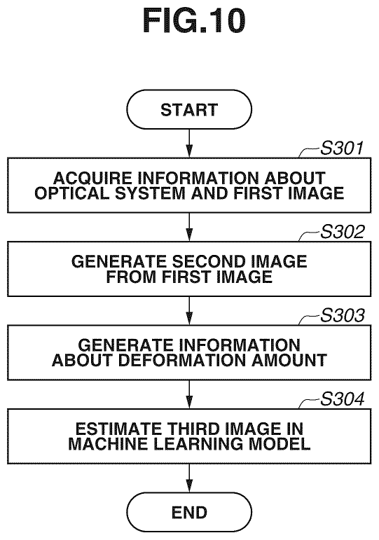

Next, the image processing method using the learned machine learning model will be described in detail with reference to FIG. 1 and FIG. 10. FIG. 10 is a flowchart illustrating the estimation phase according to the present exemplary embodiment. Steps in FIG. 10 are performed by the acquisition unit 203b, the generation unit 203c, and the estimation unit 203d.

First, in step S301, the acquisition unit 203b acquires the information 21 about the optical system, the first image 22, and the information about the weights. In the present exemplary embodiment, the information 21 about the optical system includes information about the projection method adopted by the optical system used to acquire the first image 22. The information about the weights is previously read out from the storage unit 201a, and is stored in the storage unit 203a.

Subsequently, in step S302, the generation unit 203c generates (calculates) the second image 23 by using the information 21 about the optical system and the first image 22. The second image 23 is an image generated by applying the geometric transformation to the first image 22 expressed by the equisolid angle projection method, and is expressed by the central projection method. Further, the second image 23 may be subjected to interpolation processing as necessary.

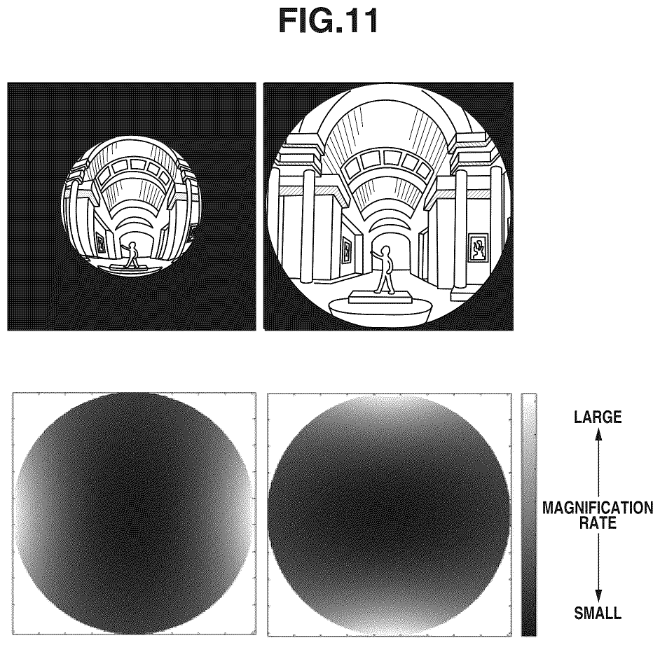

Subsequently, in step S303, the generation unit 203c generates the information 24 about the deformation amount by using the information 21 about the optical system and the first image 22. In the present exemplary embodiment, the information 24 about the deformation amount is two types of two-dimensional maps indicating the deformation amounts in the horizontal direction and the vertical direction associated with transformation (geometric transformation) from the equisolid angle projection method to the central projection method. The information 24 about the deformation amount is described with reference to FIG. 11. An upper left diagram in FIG. 11 illustrates an example of the first image 22 expressed by the equisolid angle projection method. An upper right diagram in FIG. 11 illustrates an example of the second image 23 expressed by the central projection method. A lower left diagram in FIG. 11 is a two-dimensional map indicating the deformation amount in the horizontal direction when the second image 23 is generated from the first image 22. A lower right diagram in FIG. 11 is a two-dimensional map indicating the deformation amount in the vertical direction when the second image 23 is generated from the first image 22. In the present exemplary embodiment, the two types of two-dimensional maps illustrated in the lower left diagram and the lower right diagram in FIG. 11 correspond to the information 24 about the deformation amount. A method of generating the information 24 about the deformation amount is similar to the method of generating the information 14 about the deformation amount.

Note that steps S302 and S303 in the present exemplary embodiment may be processed at the same time.

Subsequently, in step S304, the estimation unit 203d generates the third image by inputting the second image 23 and the information 24 about the deformation amount to the machine learning model. The third image 25 is an image obtained by correcting deterioration in image quality caused by the geometric transformation, in the second image 23.

As described above, according to the present exemplary embodiment, it is possible to provide the image processing system that can correct deterioration in image quality caused by the geometric transformation with high accuracy, in the second image 23 transformed in projection method by the geometric transformation.

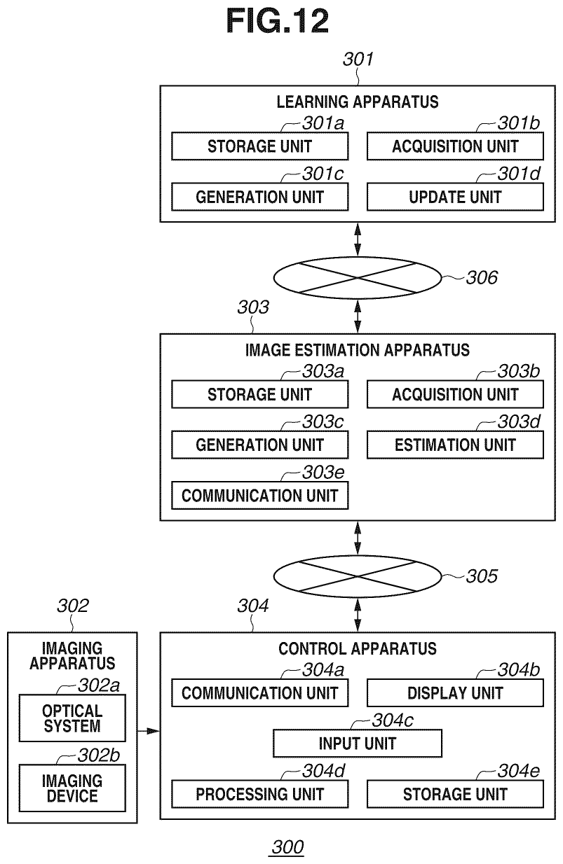

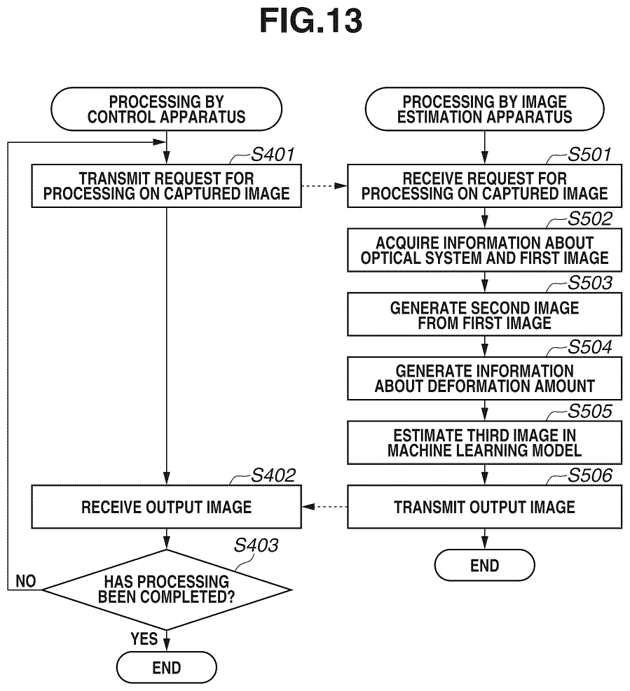

Next, an image processing system 300 according to a third exemplary embodiment will be described with reference to FIG. 12 and FIG. 13. In the present exemplary embodiment, the machine learning model is caused to learn and perform processing for correcting deterioration in image quality caused by geometric transformation.

The image processing system 300 according to the present exemplary embodiment is different from the first exemplary embodiment in that the information 21 about the optical system and the first image 22 are acquired from an imaging apparatus 302, and a control apparatus 304 requesting an image estimation apparatus (image processing apparatus) 303 to perform image processing on the first image 22 is provided.

FIG. 12 is a block diagram of the image processing system 300 according to the present exemplary embodiment. The image processing system 300 includes a learning apparatus 301, the imaging apparatus 302, the image estimation apparatus 303, and the control apparatus 304. In the present exemplary embodiment, each of the learning apparatus 301 and the image estimation apparatus 303 may be a server. The control apparatus 304 is, for example, a personal computer or a user terminal such as a smartphone. The control apparatus 304 is connected to the image estimation apparatus 303 via a network 305. The image estimation apparatus 303 is connected to the learning apparatus 301 via a network 306. In other words, the control apparatus 304 and the image estimation apparatus 303 can communicate with each other, and the image estimation apparatus 303 and the learning apparatus 301 can communicate with each other.

The learning apparatus 301 and the imaging apparatus 302 in the image processing system 300 have configurations similar to the configurations of the learning apparatus 201 and the imaging apparatus 202, respectively. Therefore, description of the configurations is omitted.

The image estimation apparatus 303 includes a storage unit 303a, an acquisition unit 303b, a generation unit 303c, an estimation unit 303d, and a communication unit (reception unit) 303e.

The storage unit 303a, the acquisition unit 303b, the generation unit 303c, and the estimation unit 303d in the image estimation apparatus 303 are respectively similar to the storage unit 203a, the acquisition unit 203b, the generation unit 203c, and the estimation unit 203d.

The control apparatus 304 includes a communication unit (transmission unit) 304a, a display unit 304b, an input unit 304c, a processing unit 304d, and a storage unit 304e. The communication unit 304a can transmit, to the image estimation apparatus 303, a request causing the image estimation apparatus 303 to perform processing on the first image 22. Further, the communication unit 304a can receive an output image processed by the image estimation apparatus 303. The communication unit 304a may communicate with the imaging apparatus 302. The display unit 304b displays various information. Various information displayed by the display unit 304b includes, for example, the first image 22, the second image 23, and the output image received from the image estimation apparatus 303. The input unit 304c can receive, for example, an instruction to start the image processing from the user. The processing unit 304d can perform arbitrary image processing on the output image received from the image estimation apparatus 303. The storage unit 304e stores the information 21 about the optical system and the first image 22 acquired from the imaging apparatus 302, and the output image received from the image estimation apparatus 303.

A method of transmitting the first image 22 to be processed, to the image estimation apparatus 303 is not limited. For example, the first image 22 may be uploaded to the image estimation apparatus 303 at the same time as step S401, or may be uploaded to the image estimation apparatus 303 before step S401. Further, the first image 22 may be an image stored in a server different from the image estimation apparatus 303.

Next, generation of the output image (estimated image) according to the present exemplary embodiment will be described. FIG. 13 is a flowchart illustrating the estimation phase according to the present exemplary embodiment.

Operation of the control apparatus 304 will be described. The image processing according to the present exemplary embodiment is started in response to an instruction to start the image processing, from the user via the control apparatus 304.

First, in step S401 (first transmission step), the communication unit 304a transmits a request for processing on the first image 22 to the image estimation apparatus 303. In step S401, the control apparatus 304 may transmit an identification (ID) for authentication of the user, the imaging condition corresponding to the first image 22, and the like, together with the request for processing on the first image 22.

Subsequently, in step S402 (first reception step), the communication unit 304a receives the third image 25 generated by the image estimation apparatus 303.

Next, operation of the image estimation apparatus 303 will be described. First, in step S501 (second reception step), the communication unit 303e receives the request for processing on the first image 22, transmitted from the communication unit 304a. The image estimation apparatus 303 performs processing in and after step S502 by receiving the instruction for processing on the first image 22.

Subsequently, in step S502, the acquisition unit 303b acquires the information 21 about the optical system and the first image 22. In the present exemplary embodiment, the information 21 about the optical system and the first image 22 are transmitted from the control apparatus 304. Note that step S501 and step S502 may be processed at the same time. Further, steps S503 to S505 are similar to steps S202 to S204. Therefore, description of steps S503 to S505 is omitted.

Subsequently, in step S506 (second transmission step), the image estimation apparatus 303 transmits the third image 25 to the control apparatus 304.

As described above, according to the present exemplary embodiment, it is possible to provide the image processing system that can correct deterioration in image quality caused by the geometric transformation with high accuracy, in the second image 23. In the present exemplary embodiment, the control apparatus 304 only requests processing on a specific image. The actual image processing is performed by the image estimation apparatus 303. Therefore, when the user terminal serves as the control apparatus 304, a processing load on the user terminal can be reduced. As a result, the user can obtain the output image with a low processing load.

### Other Exemplary Embodiments

Some embodiments of the present disclosure can be realized by supplying computer-executable instructions realizing one or more functions of the above-described exemplary embodiments to a system or an apparatus via a network or a storage medium, and causing one or more processors in a computer of the system or the apparatus to read out and execute the programs. Further, some embodiments of the present disclosure can be realized by a circuit (e.g., application specific integrated circuits (ASIC)) realizing one or more functions. The image processing apparatus according to the present disclosure is an apparatus including the image processing function according to the present disclosure, and can be realized in a form of an imaging apparatus or a personal computer (PC).

According to the exemplary embodiments, it is possible to provide the image processing method, the image processing system, and the program that can correct deterioration in image quality caused by geometric transformation with high accuracy, in the image subjected to the geometric transformation.

Although some exemplary embodiments of the present disclosure have been described above, some embodiments are not limited to these exemplary embodiments, and various modifications and alternations can be made within the scope of the present disclosure.

### Other Embodiments

Some embodiment(s) of the present disclosure can also be realized by a computer of a system or apparatus that reads out and executes-computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2022-115905, which was filed on Jul. 20, 2022 and which is hereby incorporated by reference herein in its entirety.

What is claimed is:

1. An image processing method, comprising:
acquiring a second image obtained by applying geometric transformation to a first image;
acquiring information about a deformation amount of the first image in the geometric transformation; and
generating a third image based on the second image and the information about the deformation amount.

2. The image processing method according to claim 1, wherein the third image is generated by inputting the second image and the information about the deformation amount to a machine learning model.

3. The image processing method according to claim 1, wherein the information about the deformation amount includes a ratio of a distance between two points in the first image and a distance between two points in the second image corresponding to the two points in the first image.

4. The image processing method according to claim 1, wherein the information about the deformation amount includes a ratio of an area of a region in the first image and an area of a region in the second image corresponding to the region in the first image.

5. The image processing method according to claim 1, wherein the information about the deformation amount includes a moving amount from one point in the first image to one point in the second image corresponding to the one point in the first image.

6. The image processing method according to claim 1, wherein the information about the deformation amount includes a value of the deformation amount at each position of a pixel in the first image.

7. The image processing method according to claim 1, wherein the information about the deformation amount is two or more types of two-dimensional maps indicating deformation amounts corresponding to directions different from each other in the geometric transformation.

8. The image processing method according to claim 1, wherein the geometric transformation is transformation varied in the deformation amount depending on a position of a pixel in the first image.

9. The image processing method according to claim 1, wherein the geometric transformation is transformation from a first projection method of the first image to a second projection method of the second image.

10. A non-transitory computer-readable storage medium that stores computer-executable instructions that, when executed by a computer, cause the computer to:
acquire a second image obtained by applying geometric transformation to a first image;
acquire information about a deformation amount of the first image in the geometric transformation; and
generate a third image based on the second image and the information about the deformation amount.

11. An image processing apparatus, comprising:
one or more memories; and
one or more processors, wherein the one or more processors and the one or more memories are configured to:
acquire a second image obtained by applying geometric transformation to a first image;
acquire information about a deformation amount of the first image in the geometric transformation; and
generate a third image based on the second image and the information about the deformation amount.

12. An image processing system, comprising:
an image processing apparatus; and
a control apparatus configured to communicate with the image processing apparatus,
wherein the image processing apparatus includes
one or more memories; and
one or more processors, wherein the one or more processors and the one or more memories are configured to:
acquire a second image obtained by applying geometric transformation to a first image;
acquire information about a deformation amount of the first image in the geometric transformation;
generate a third image based on the second image and the information about the deformation amount; and
perform processing on the first image in response to a request, and
wherein the control apparatus includes
one or more memories; and
one or more processors, wherein the one or more processors and the one or more memories are configured to:
transmit the request for causing the image processing apparatus to perform processing on the first image obtained by imaging using an optical system and an imaging device.

13. A method of generating a machine learning model, the method comprising:
acquiring a first training image obtained by imaging using an optical system and an imaging device, information about the optical system, and a ground truth image;
generating a second training image by applying a geometric transformation to the first training image based on the information about the optical system;
acquiring information about a deformation amount of the first training image in the geometric transformation;
generating an estimated image by inputting the second training image and the information about the deformation amount to a machine learning model; and
updating a weight of the machine learning model based on the ground truth image and the estimated image.

14. A learning apparatus, comprising:
one or more memories; and
one or more processors, wherein the one or more processors and the one or more memories are configured to:
acquire a first training image obtained by imaging using an optical system and an imaging device, information about the optical system, and a ground truth image;
generate a second training image by applying geometric transformation to the first training image based on the information about the optical system;
acquire information about a deformation amount of the first training image in the geometric transformation;
generate an estimated image by inputting the second training image and the information about the deformation amount to a machine learning model; and
update a weight of the machine learning model based on the ground truth image and the estimated image.

15. An image processing system, comprising:
a learning apparatus; and
an imaging apparatus configured to communicate with the learning apparatus,
wherein the learning apparatus includes
one or more memories; and
one or more processors, wherein the one or more processors and the one or more memories are configured to:
acquire a first training image obtained by imaging using an optical system and an imaging device, information about the optical system, and a ground truth image;
generate a second training image by applying geometric transformation to the first training image based on the information about the optical system;
acquire information about a deformation amount of the first training image in the geometric transformation;
generate an estimated image by inputting the second training image and the information about the deformation amount to a machine learning model; and
update a weight of the machine learning model based on the ground truth image and the estimated image, and
wherein the imaging apparatus includes
the optical system,
the imaging device,
one or more memories, and
one or more processors, wherein the one or more processors and the one or more memories are configured to
acquire a first image acquired using the optical system and the imaging device, and information about the optical system,
generate a second image by applying a geometric transformation to the first image based on the information about the optical system,
acquire information about a second deformation amount of the first image in the geometric transformation of the first image, and
generate a third image by inputting the second image and the information about the second deformation amount to the machine learning model.
